(19) United States
(12) Patent Application Publication
(10) Pub. No.: US 2002/0078057 A1
(43) Pub. Date: Jun. 20, 2002

(54) Lookup table approach for dynamically duplicating websites

(76) Inventors: John Y. Wang, Livermore, CA (US); Evan Y. Wang, Fremont, CA (US)

Correspondence Address: SAWYER LAW GROUP LLP, P.O. Box 51418, Palo Alto, CA, 94303, US

(21) Appl. No.: 09/742,866

(22) Filed: Dec. 20, 2000

(51) Int. Cl. G06F 7/00

(52) U.S. Cl. 707/100

(57) ABSTRACT

A method and system for creating a new website from an existing website is disclosed. The existing website comprises a plurality of content items, wherein at least a portion of the content items include a reference link to other content items. The method and system include storing each of the content items in a first table, where each of the content items is represented by a content ID. Each of the content items are then duplicated in the table and a new content ID is assigned to each of the duplicate content items. Next, the content ID of each content item and the content ID of the corresponding duplicate content item are inserted into a lookup table as a source ID and a destination ID, respectively. The method and system further include finding each of the duplicate content items in the first table, and using the reference link of the duplicate content item as a source ID index in the lookup table to replace the reference link with the corresponding destination ID in the lookup table.

### FIELD OF THE INVENTION

The present invention relates to duplicating websites, and more particular to a method for automatically creating a new website from an existing website and for updating reference links therein.

### BACKGROUND OF THE INVENTION

There are many sites on the Internet today that are hosted for associations where each member of the association is provided with a separate web site.

Examples of such associations include a realtor company in which each realtor in the company is provided with an individual website, and an association of plumbers in which each plumber belonging to the group has an individual website, and so on. Usually, each of the websites in the association contains the same or very similar content to maintain a consistent look and feel across all the association's websites. When a new member joins the association, a new website must be created for the new member.

Instead of creating the new website from scratch, the website is typically created using website templates. The website templates are HTML pages that specify the layout of the website and may contain content that is common to each of the websites, such as banner ads and logos. Each of the websites may also share common applications, such as e-mail, calculator, and calendar applications, for instance. Although templates are helpful for starting a new website, the templates must be manually filled-in with additional content, which is time consuming. A solution to this problem is to manually copy each web page from an existing website to a new location, rather than using templates, thereby maintaining the content. But depending on the size of the website, this approach may require as much manual labor.

After creating the new site using either approach, the reference links included in the new website should not point to content in the original website. Rather, the reference links in the new site should point to content in the new site, meaning that the reference links must be updated by hand. For large websites, the number of links could number in the hundreds or thousands, and manually updating each of the reference links would be tedious and error prone.

Accordingly, what is needed is improved method and system for creating to a new web site from an existing web site. The present invention addresses such the need.

### SUMMARY OF THE INVENTION

The present invention provides a method and system for creating a new website from an existing website. The existing website comprises a plurality of content items, wherein at least a portion of the content items include a reference link to other content items. The method and system include storing each of the content items in a first table, where each of the content items is represented by a content ID. Each of the content items is then duplicated in the table and a new content ID is assigned to each of the duplicate content items. Next, the content ID of each content item and the content ID of the corresponding duplicate content item are inserted into a lookup table as a source ID and a destination ID, respectively. The method and system further include finding each of the duplicate content items in the first table, and using the reference link of the duplicate content item as a source ID index in the lookup table to replace the reference link with the corresponding destination ID in the lookup table.

According to the system and method disclosed herein, association members are allowed to instantly create a new website from an existing one, where the new website is usably immediately, without having to fill-in association specific content. In addition, the new website will have the most up-to-date content (e.g., news articles).

### BRIEF DESCRIPTION OF THE DRAWINGS

FIG. 1 is a block diagram illustrating a web application for copying websites.

FIGS. 2A-2B are block diagrams graphically illustrating the copying of an example website “X”.

FIG. 3 is a flow chart illustrating a process for dynamically creating a new website from the existing website using the lookup table.

FIG. 4 is a block diagram illustrating the database tables.

FIGS. 5A-5E are lookup tables that are used by the application object routines during the website duplication process.

FIG. 6 is a flow chart illustrating a process for duplicating a website from an existing website and updating the links using the lookup table in further detail.

### DETAILED DESCRIPTION

The present invention relates to providing a web application for copying websites and updating reference links using a lookup table approach. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiments shown but is to be accorded the widest scope consistent with the principles and features described herein.

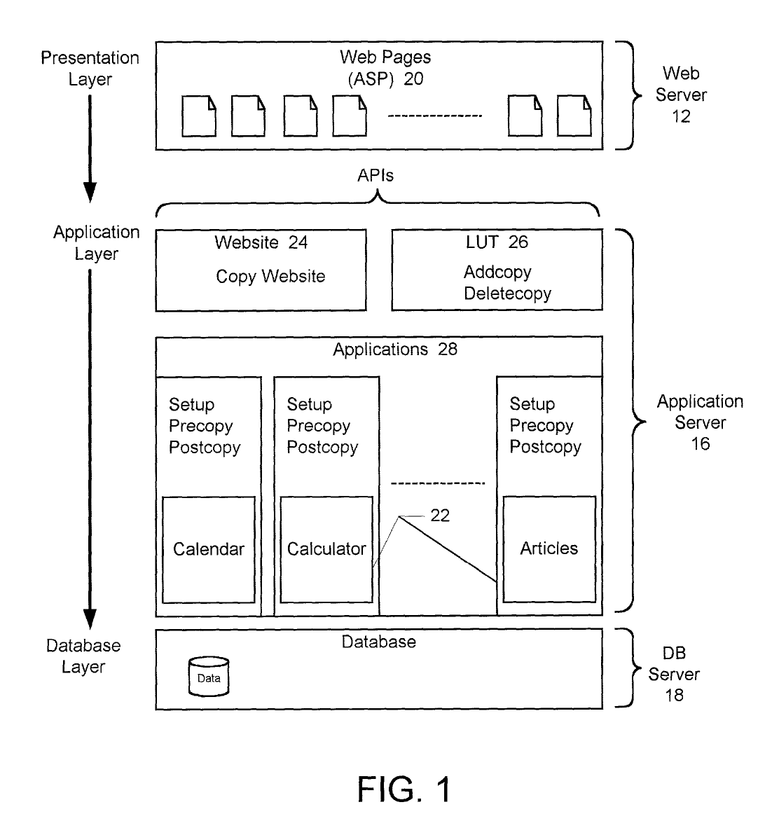

FIG. 1 is a block diagram illustrating a web application for copying websites in accordance with one preferred embodiment the present invention. The web application 10 includes a web server 12 for presenting web pages to a web browser (not shown) from an application server 16. The application server 16 typically interfaces with a database server 18. Logic wise, the web server 12 provides the presentation layer, the application server 16 provides the application layer, and the database server 18 provides the database layer. The web server 12, the application server 16 software, and the database server 18 may reside on the same or different computers.

The web application 10 may host a variety of websites for different associations and its members. In a preferred embodiment, each website comprises a plurality of web pages 20, preferably active server pages (ASPs). An ASP is a web page 20 that contains HTML and embedded programming code written in a language such as VBScript or JavaScript that is executed in the web server 12 or the application server 16. When a web browser makes a request for an ASP, the web server 12 executes the embedded program, and the HTML in the ASP provides the page layout that will be returned to the web browser. The programming code provides the processing for the page, such as delivering search data entered on a web page to the database 18 for lookup. It would also format the results of that search as HTML and send it back to the user. ASPs are Microsoft's alternative to CGI scripts and JavaServer Pages (JSPs), which allow Web pages to interact with databases and other programs. Third party products add ASP capability to nonMicrosoft Web servers.

The programming code is implemented using a programming interface, on the web server 12, such as the well-known Internet Server API, that allows the web pages 20 to invoke application objects 22 and other routines through function calls. In a preferred embodiment, the application server 16 is provided with a website API 24, a lookup table API 26, and an application API 28, which accesses the application objects 22. The application objects 22 are programs similar to DLLs that may access data in the database depending on their function.

Examples of application objects 22 that may be included in a website include a calendar object, a calculator object, a web mail object, a catalog object, an articles object, and so. When invoked within a website, the calendar object provides the website with an interactive calendar function. The calculator object may implement any type of calculator, such as a mortgage calculator that accesses regionalized interest rates for example. The catalog object may provide e-commerce functionality. And the articles object may provide any type of desired content (e.g., text, graphics, images, and so on).

Each of the application objects 22 are assigned a unique application ID, and each of the websites hosted by the web server 12 may incorporate different combinations of application objects 22 by referencing the application IDs of the desired application objects 22. Once referenced in a particular website, the application objects 22 may be automatically invoked, or may be invoked by a user by clicking on a link.

As is well-known, website content items such as application objects 22 and web pages 20 may include reference links (e.g. hypertext links) to other web pages 20 and application objects 22 within the website.

In some instances, it may be desirable to create a new website from an existing website. As stated above, one method for creating a new website is to use templates that form the shell of some of the web pages comprising the site, but the content for the new site must be filled in manually. Another approach is to manually copy each web page in the existing website to new location. Typically, a web administrator would have to manually copy each page. And since the reference links in the new site will point to content items in the existing site, the administrator would have to manually update each link to point to the content items within the new site. For large websites, the number of links could number in the hundreds or thousands, and manually updating each of the reference links would be tedious and error prone.

The present invention provides a method and system for dynamically creating new website from an existing website in which the contents of the existing site are automatically ascertained and duplicated, and where the links in the copied site are automatically updated using a lookup table.

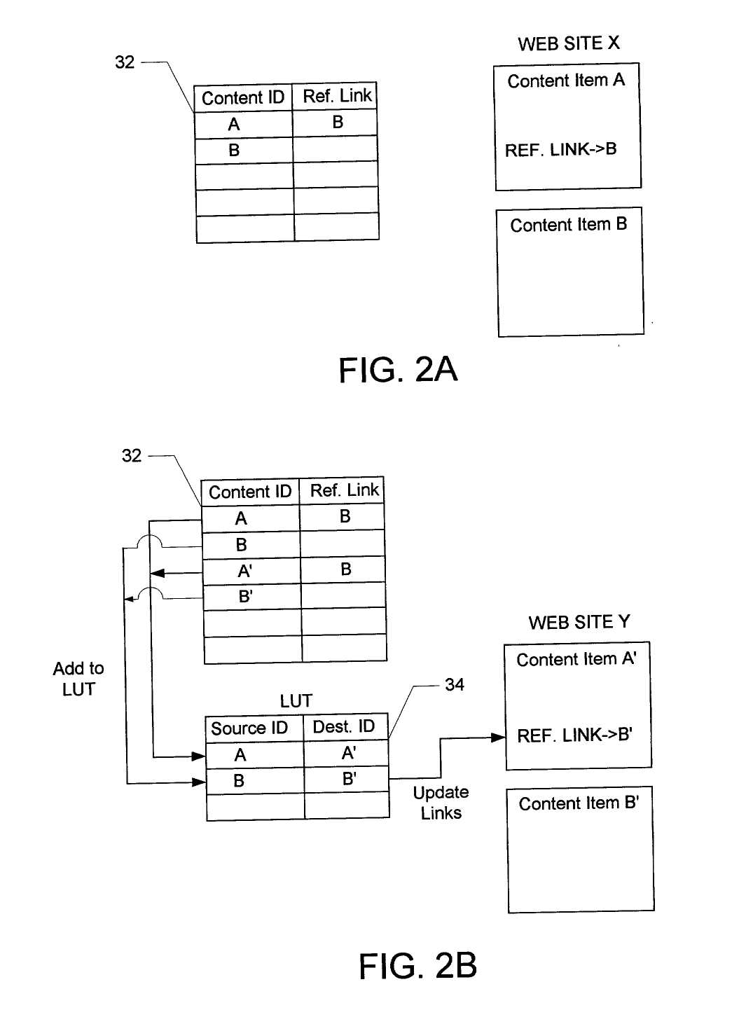

FIGS. 2A-2B are block diagrams graphically illustrating the copying of an example website “X”. Example website X is shown including several content items, each identified by a content ID, shown here as A and B. In the example, content item A includes a reference link to content item B. The present invention allows an association member who is accessing website X to create a new website Y where the contents of website X are dynamically copied to create website Y, and the reference links in website Y are automatically updated to point to the new content items in website Y.

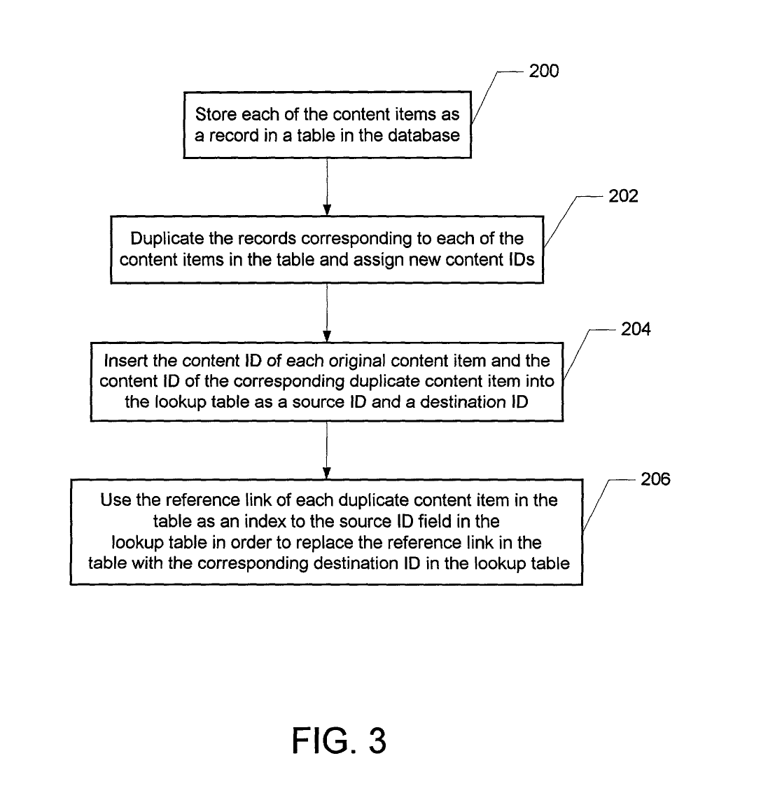

FIG. 3 is a flow chart illustrating a process for dynamically creating a new website from the existing website using a lookup table using in FIG. 2 as an example. The process begins by storing each of the content items as a record in a table in the database in step 200. As shown in FIG. 2A, the content ID of content items A and B in the website are stored in table 32 along with the corresponding reference links.

Referring again to FIG. 3, the records corresponding to each of the content items in the table are then duplicated in the table and assigned new content IDs in step 202. As shown in FIG. 2B, the content items A and B are duplicated in the table 32 and assigned new content IDs A′ and B′, respectively, creating website Y.

Referring again to FIG. 3, after the content item records are duplicated, the content ID of each original content item in the table and the content ID of the corresponding duplicate content item are inserted into a lookup table as a source ID and a destination ID, respectively in step 204. As shown in FIG. 2B, the content IDS for content items A and A′ are stored in the lookup table 34 as a source/destination pair, and the content IDs for B and B′ are stored in the lookup table as a source/destination pair.

Referring again to FIG. 3, after the content ID's are added to the lookup table, each reference link for a duplicate content item in the table is used as an index to the source ID field in the lookup table in order to replace the reference link in the table with the corresponding destination ID in the lookup table in step 206. For example, referring to FIG. 2B, the reference link B corresponding to the duplicate content item A′ in the table 32 is used to search the source ID field in the lookup table 34 to find the matching source ID B. The corresponding destination ID, B′, in the lookup table 34 is then used to replace the reference link B with B′ in the table 32. As a result, the new website Y is created with the same contents as the existing website X, but the reference links have been automatically updated to point to content items within website Y.

According to the present invention, the new website is created using a two-stage lookup table approach, whereby in the first stage the lookup table 34 is filled with content IDs from the existing website (source IDs) and the corresponding content IDs of the new site (destination IDs). In the second stage, the lookup table 34 is indexed by the source ID in order to update the reference links in the new website with the corresponding destination IDs in the lookup table 34.

In a further aspect of the invention, the method for duplicating websites is dynamic because it is data driven. That is, the content associated with any given website is variable, and the web application has the ability to automatically ascertain what content is associated with the website being copied and effectively copy the content to create the new website. This allows association members to instantly create a new website from an existing one, where the new website is usably immediately, without having to fill-in association member-specific content. In addition, the new website will have the most up-to-date content (e.g., news articles).

In a preferred embodiment, the lookup table 34 is used in an implementation whereby the hosted websites and content items comprising the websites are stored in tables in the database 18. In addition, the application server 16 is provided with an application programming interface (API) containing software routines for accessing and manipulating the database tables and the lookup table 32.

Referring again to FIG. 1, in a preferred embodiment, the application server 16 is provided with a “copy-website” routine that is available for websites to display as a hyperlink on a web page to allow an association member, rather than a website administrator, to invoke the process of generating a new website from the existing site by clicking on the link from a web browser. In addition, the application objects 22 available for use in the websites are each provided with three API routines: setup, precopy, and postcopy, and the lookup table 34 is provided with two API routines; addcopy and delete copy, explained further below.

In operation, the copy-website routine triggers the application object routines, which in turn, call the lookup table routines. During the copying process, the sequential calling of the application object routines effects a two-pass process of using the LUT to automatically copy the application objects 22 used in the existing website to the new website and to automatically update the links in the new website.

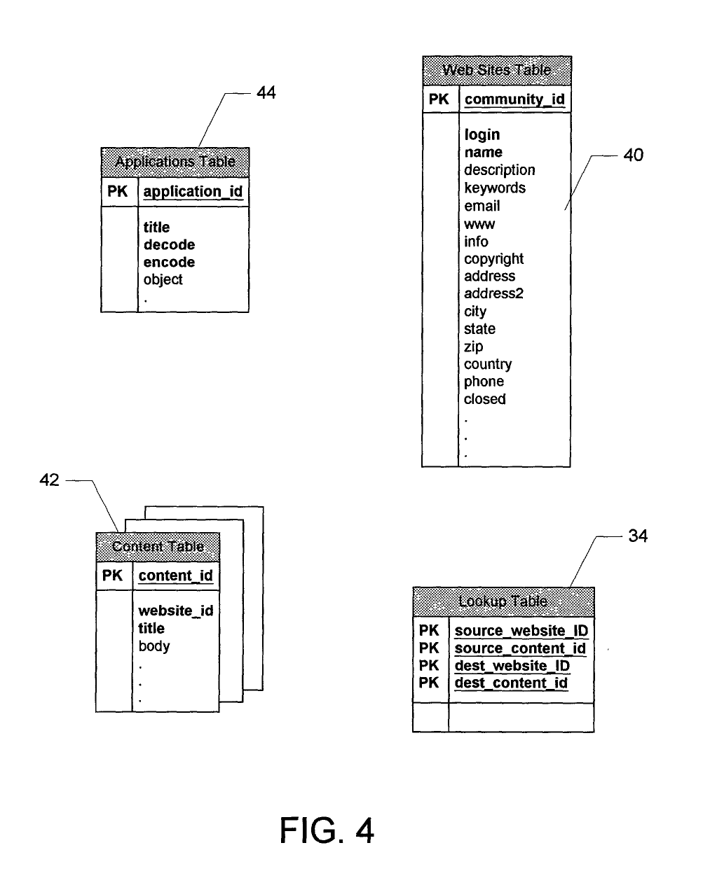

Referring to FIG. 4, a block diagram illustrating the database tables for implementing the present invention are shown. In a preferred embodiment, the database 18 includes a websites table 40, multiple application content tables 42, an applications table 44, and the lookup table 34. Each of the websites hosted by the web server 12 are stored as a record in a websites table 40. The record includes several fields for identifying the website and its properties, such as a website ID that uniquely identifies the website and that serves as the primary key (PK), a login, and name, for instance.

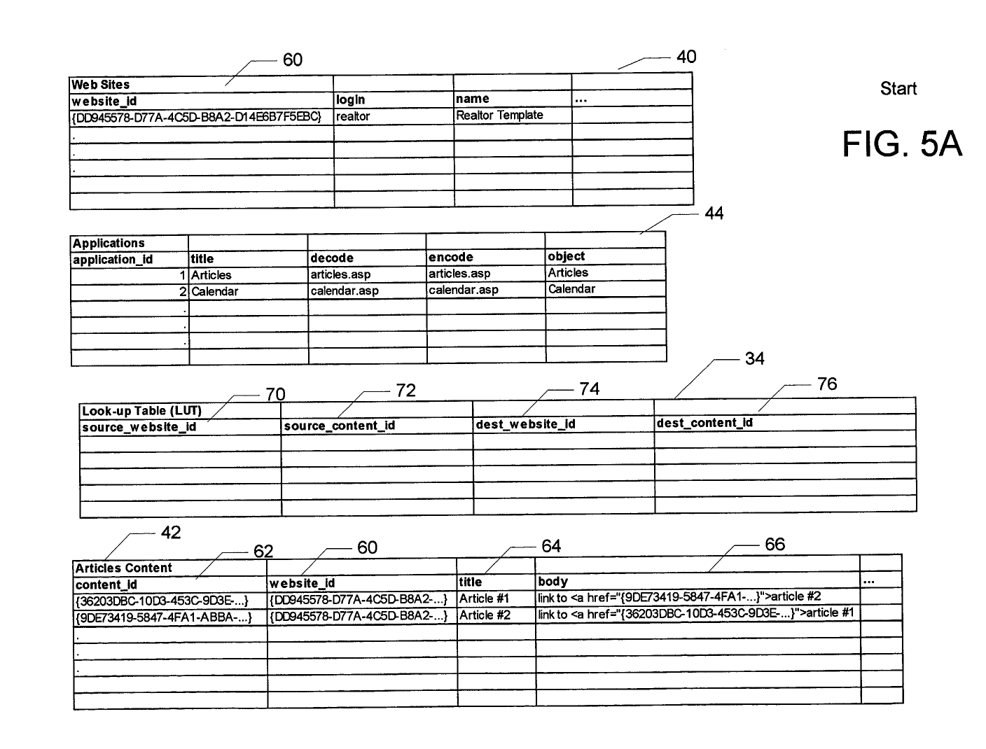

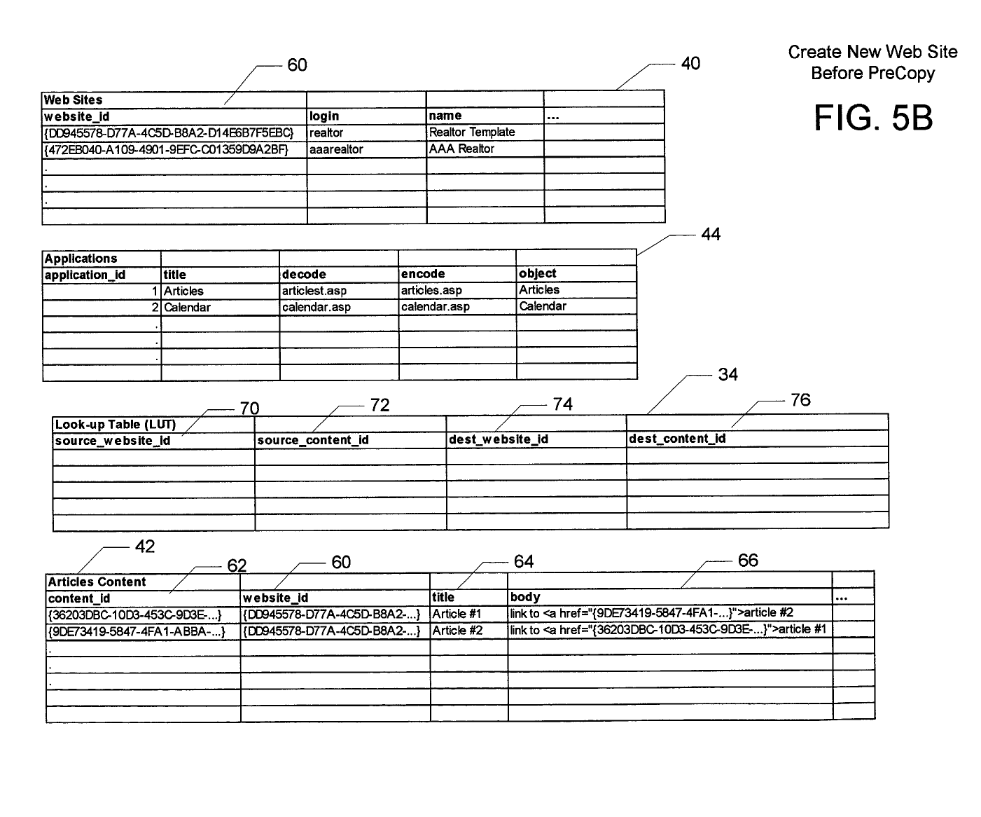

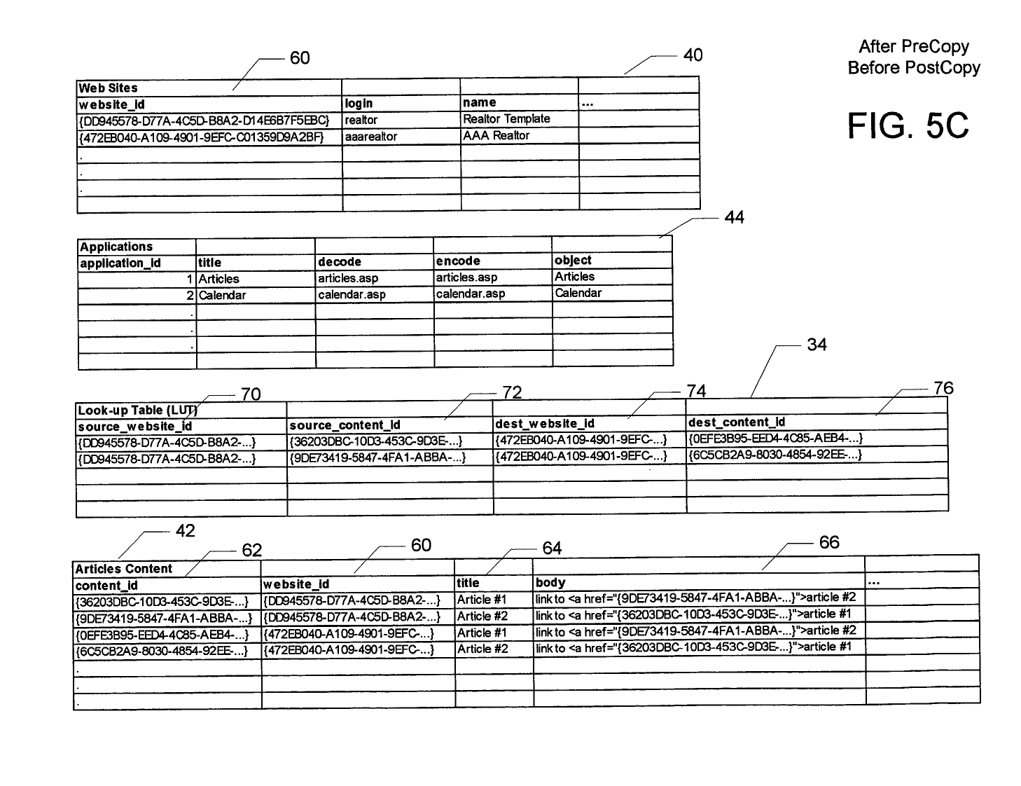

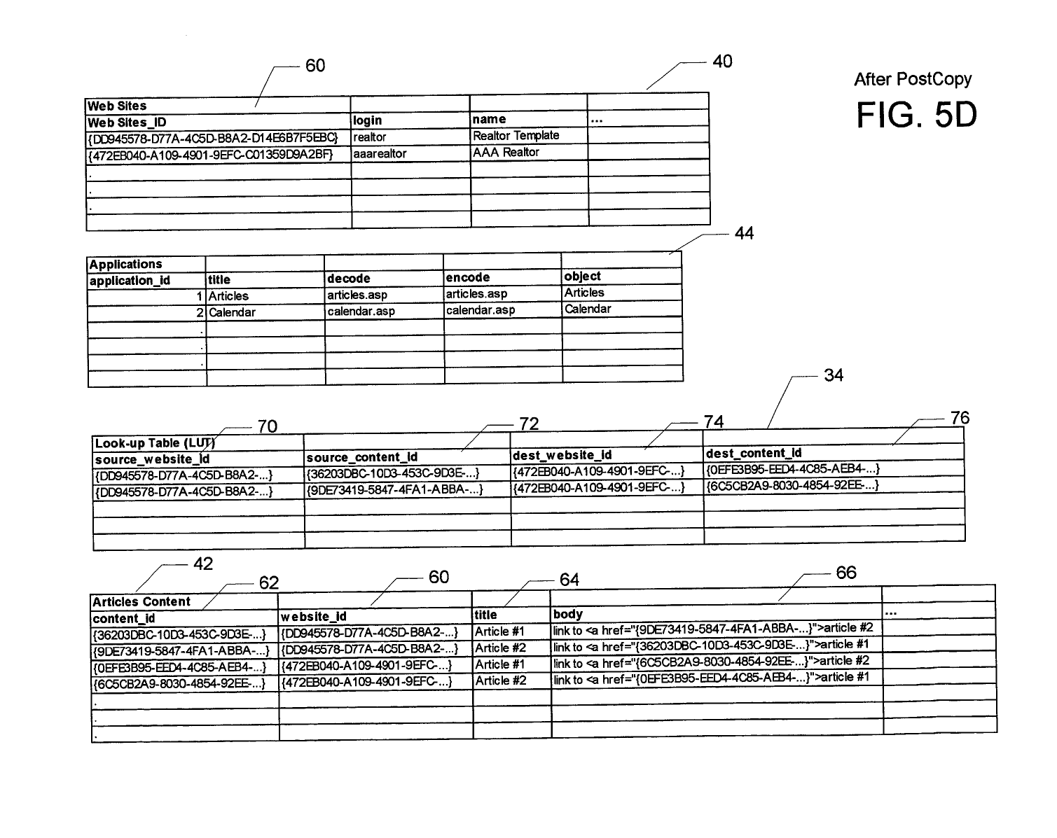

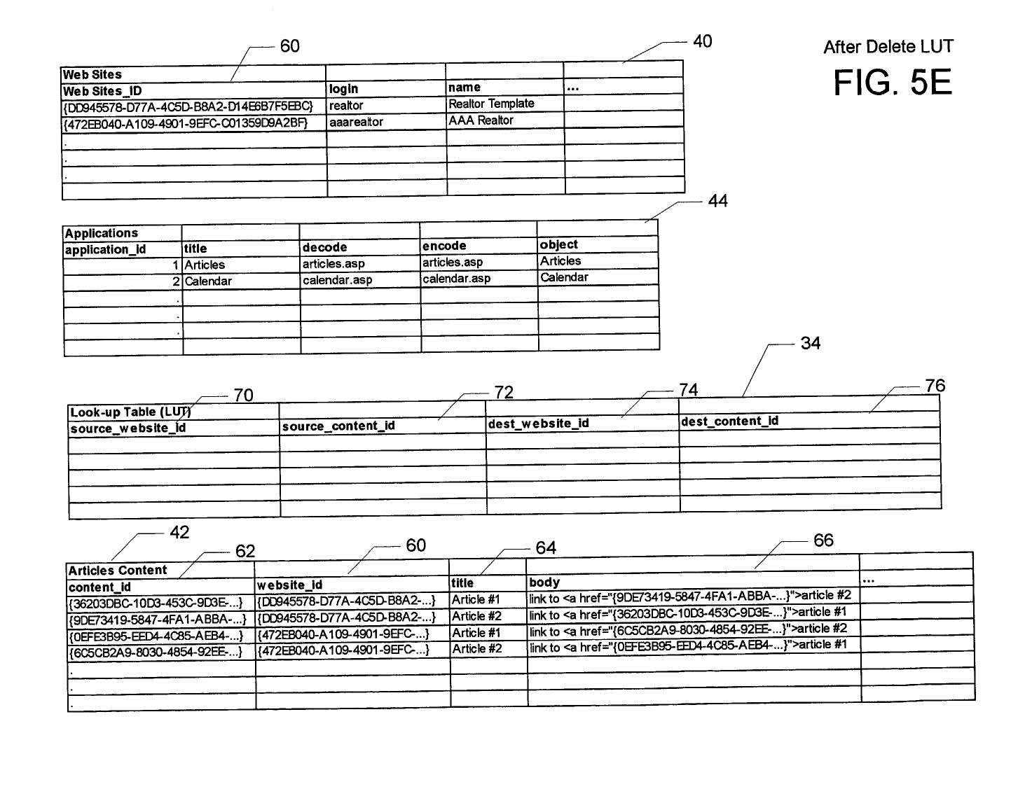

FIGS. 5A-5E are diagrams illustrating the database tables with example data during the process of website duplication. Referring to FIG. 5A, the websites table 40 is shown having a record for a realtor website, which is identified by a website ID 60.

According to the present invention, the applications table 44 is used to store an entry for every web page in the website that contains an application object 22. In a preferred embodiment, each application object 22 referenced in the website has a respective application content table 42. For example, referring to FIG. 5A, the page type table 44 is shown having two entries, the titles for which are “articles” and “calendar”. This means that the realtor website accesses an articles application object and a calendar application object. The decode and encode fields of the page type table 44 identify which ASP pages are used to display the page for the user, and the website administrator, respectively. And the object field is the name of the corresponding application object. The application ID matches the web page type listed in the title field with a physical DLL object. If the pagetype ID is null, then that page has no corresponding object and may just contain static text and/or graphics.

Each of the application objects 22 appearing in the applications table 44 has a corresponding application content table 42. For example, the articles object includes entries in a corresponding articles content table 42. Similarly, the calendar object includes entries in a corresponding calendar content table (not shown). Each application content table 42 includes a unique content ID 62 identifying the particular content, the website ID 60 of the website, the title 64 of the content, and a body 66 containing the reference link to the web page and other content.

Also shown in FIG. 5A is the lookup table 34 that is used by the application object routines during the website duplication process. In a preferred embodiment, the lookup table 34 includes the following fields a source website ID 70, a source content ID 72, a destination website ID 74, and a destination content ID 76, to be used as described below.

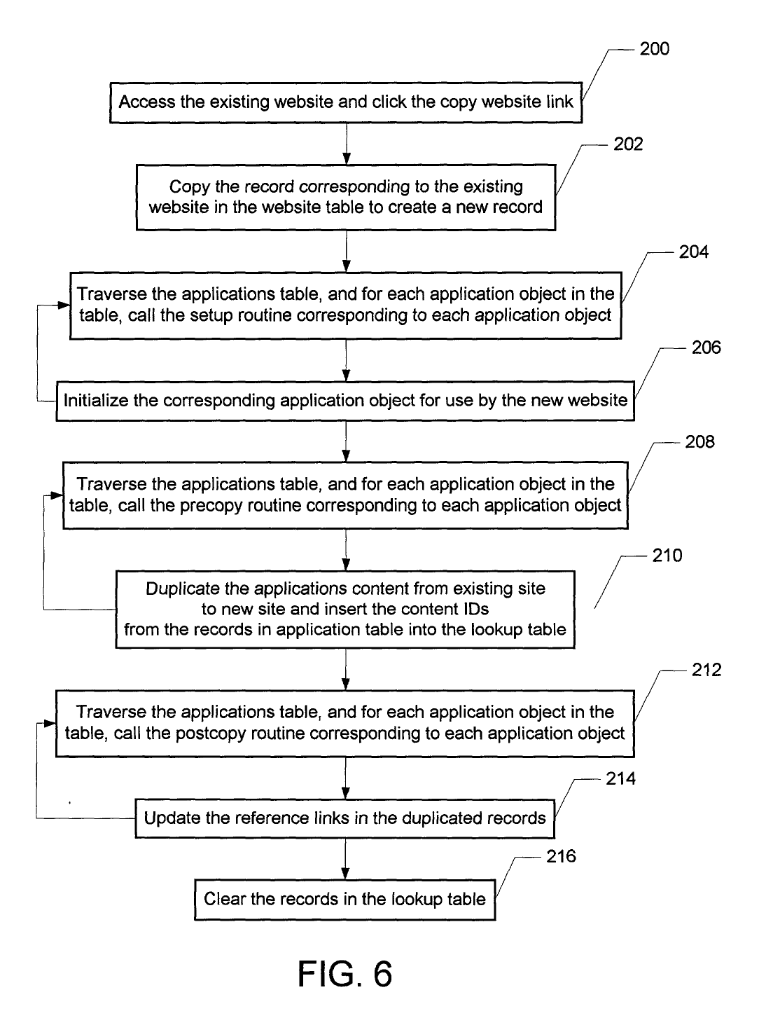

FIG. 6 is a flow chart illustrating a process for duplicating a website from an existing website and updating the links using the lookup table in further detail. The process begins when an association member accesses the existing website and clicks the copy-website link in step 200. In response, the record corresponding to the existing website in the websites table 40 is copied in the websites table 40 to create a new record in step 202 as shown in FIG. 5B a AAA realtor website record is created in the websites table 40 from the realtor website record and the new record is assigned a new website ID, login, and name.

Next, the lookup scheme of the present invention is used to update the links in the copied website by performing the following steps. First, the copy website routine traverses the applications table 44, and for each application object 22 in the table 44, the setup routine corresponding to each application object 22 is called in step 204. Each setup routine initializes the corresponding application object for use by the new website in step 206. For example, for an e-commerce application object, the setup routine may be invoked by the command “ecommerce.setup”, and once invoked, the setup routine might initialize a tax table for a certain geographic location, for instance.

After the setup routine corresponding to each object is called, the applications table 44 is traversed, and for each application object 22 in table, the precopy routine corresponding to each application object 22 is called in step 208. Each precopy routine allows the corresponding application object 22 to duplicate content in the application content table 42 and to insert the content IDs 62 from the records into the lookup table 34 in step 210. In a preferred embodiment, the precopy routine inserts data into the lookup table 34 by calling an addcopy routine associated with the lookup table shown in FIG. 1.

FIG. 5C graphically depicts the operation of the precopy routine, using the sample content application object as an example. First the precopy routine copies the records in the application content table 42 and assigns new content Ids 62 to the copied records. Next, the precopy routine inserts the website ID 60 and the content ID 62 of each original record in the application content table 42 into the source website ID 70 and source content ID 72 fields, respectively, of the lookup table 34; and copies the website ID 60 and the content ID 62 of the corresponding copied record into the destination website ID 74 and destination content ID 76 fields, respectively, of the lookup table 34.

Referring again to FIG. 6 after the precopy process is completed for each application object, the applications table 44 is traversed again, and for each application object 22 in the table, the postcopy routine corresponding to each application object 22 is called in step 212. Each postcopy routine updates the reference links in the copied records in step 214 as follows. Referring to FIG. 5C, first, the application content table 42 is traversed and for each duplicated record found, its corresponding reference link in the body 66 is used as an index into the source content ID 72 field of the lookup table 34. The destination content ID 76 of the matching record in the lookup table 34 is then used to replace the reference link in the duplicated record in application content table 42, as shown in FIG. 5D. In a preferred embodiment, the post copy routine uses a lookup routine associated with the lookup table shown in FIG. 1.

The result is that a new AAA realtor website is automatically and dynamically created from the realtor web site with duplicate content and with the correct links, with no operator intervention required.

After clearing the lookup table in step 216, the lookup table 34 is free to facilitate the copying of another new website.

According to the present invention, because the application objects are stored in database tables, the process for copying the website and updating links may be performed faster. In addition, the precopy process allows the application object to process its own data without using the lookup table, and to copy its data into the lookup table for later use, while the post copy process updates the reference links through the benefit of the lookup table.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

What is claimed is:

1. A method for creating a new website from an existing website, the existing website comprising a plurality of content items, wherein at least a portion of the content items include a reference link to other content items, the method comprising the step of:
(a) storing each of the content items in a first table, wherein each of the content items is represented by a content ID;
(b) duplicating each of the content items in the table and assigning a new content ID to each of the duplicate content items;
(c) inserting the content ID of each content item and the content ID of the corresponding duplicate content item into a lookup table as a source ID and a destination ID, respectively; and
(d) for each of the duplicate content items in the first table,
(ii) using the reference link as a source ID index in the lookup table, and
(iii) replacing the reference link with the corresponding destination ID in the lookup table.

2. The method of claim 1 further including the step of implementing at least a portion of the content items as application objects.

3. The method of claim 2 further including the step of providing an application programming interface (API) containing software routines for accessing and manipulating the first table and the lookup table.

4. The method of claim 3 further including the step of providing the existing website with a routine that is displayed as a link on a web page that functions to invoke the duplication process when the link is clicked from a web browser.

5. The method of claim 4 further including the step of providing each of the application objects with a first routine for initializing the corresponding application object for use by the new website.

6. The method of claim 5 further including the step of providing each of the application objects with a second routine for allowing the corresponding application object to duplicate itself in the first table and to insert the content IDs from records in the first table into the lookup table.

7. The method of claim 6 further including the step of providing each of the application objects with a third routine for performing steps (d)(i) and (d)(ii).

8. A system for creating a new website from an existing website, the existing website comprising a plurality of content items, wherein at least a portion of the content items include a reference link to other content items, the system comprising:
means for storing each of the content items in a first table, wherein each of the content items is represented by a content ID;
means for duplicating each of the content items in the table and assigning a new content ID to each of the duplicate content items;
means for inserting the content ID of each content item and the content ID of the corresponding duplicate content item into a lookup table as a source ID and a destination ID, respectively; and
means for finding each of the duplicate content items in the first table and for using the reference link as a source ID index in the lookup table to replace the reference link with the corresponding destination ID in the lookup table.

9. The system of claim 8 wherein at least a portion of the content items are implemented as application objects.

10. The system of claim 9 further including an application programming interface (API) containing software routines for accessing and manipulating the first table and the lookup table.

11. The system of claim 10 further including a routine for the existing website that is displayed as a link on a web page that functions to invoke the duplication process when the link is clicked from a web browser.

12. The system of claim 11 wherein each of the application objects includes a first routine for initializing the corresponding application object for use by the new website.

13. The system of claim 12 wherein each of the application objects includes a second routine for allowing the corresponding application object to duplicate itself in the first table and to insert the content IDs from records in the first table into the lookup table.

14. The system of claim 13 wherein each of the application objects includes a third routine for indexing the lookup table and updating the links.

15. A computer readable medium containing program instructions for creating a new website from an existing website, the existing website comprising a plurality of content items, wherein at least a portion of the content items include a reference link to other content items, the program instructions for:
(a) storing each of the content items in a first table, wherein each of the content items is represented by a content ID;
(b) duplicating each of the content items in the table and assigning a new content ID to each of the duplicate content items;
(c) inserting the content ID of each content item and the content ID of the corresponding duplicate content item into a lookup table as a source ID and a destination ID, respectively; and
(d) for each of the duplicate content items in the first table,
(ii) using the reference link as a source ID index in the lookup table, and
(iii) replacing the reference link with the corresponding destination ID in the lookup table.

16. The computer readable medium of claim 15 further including the instruction of implementing at least a portion of the content items as application objects.

17. The computer readable medium of claim 16 further including the instruction of providing an application programming interface (API) containing software routines for accessing and manipulating the first table and the lookup table.

18. The computer readable medium of claim 17 further including the instruction of providing the existing website with a routine that is displayed as a link on a web page that functions to invoke the duplication process when the link is clicked from a web browser.

19. The computer readable medium of claim 18 further including the instruction of providing each of the application objects with a first routine for initializing the corresponding application object for use by the new website.

20. The computer readable medium of claim 19 further including the instruction of providing each of the application objects with a second routine for allowing the corresponding application object to duplicate itself in the first table and to insert the content IDs from records in the first table into the lookup table.

21. The computer readable medium of claim 20 further including the instruction of providing each of the application objects with a third routine for performing instructions (d)(i) and (d)(ii).
